(19) United States
(12) Patent Application Publication
(10) Pub. No.: US 2016/0311529 A1
(43) Pub. Date: Oct. 27, 2016

(54) Modular Electric VTOL Aircraft

(71) Applicant: Neva Aerospace, Ltd.

(72) Inventors: David Brotherton-Ratcliffe, Sussex (GB); Laurent Martin, Paris (FR)

(21) Appl. No.: 15/104,614

(22) PCT Filed: Dec. 17, 2014
(86) PCT No.: PCT/GB2014/053724

§ 371 Date: Jun. 15, 2016

(30) Foreign Application Priority Data
Dec. 18, 2013 (GB) 1322401.9

(51) Int. Cl. B64C 29/00; B64C 27/20; B64C 37/02; B64C 39/02; B64D 35/06; G05D 1/00; G08G 5/00; B64D 27/10; B64D 35/04; B64D 27/24; B64C 27/30; G01C 21/16

(52) U.S. Cl. CPC B64C 29/0033; B64C 27/30; B64C 27/20; B64C 37/02; B64C 39/024; G01C 21/16; G05D 1/0088; G08G 5/0034; B64D 27/10; B64D 35/04; B64D 27/24; B64D 35/06; B64C 2201/042; B64C 2201/162; B64C 2211/00; B64C 2201/108; B64C 2201/141; B64C 2201/088; B64C 2027/8227

(57) ABSTRACT

A VTOL aircraft is disclosed comprising a plurality of autonomous lifting modules wherein each autonomous lifting module is composed of a physical structure in which are mounted one or more electric ducted fans, an electrical energy storage system to drive the electric ducted fans, a charging and energy storage monitoring system to charge and monitor the electrical energy storage system, an inertial navigation system, electronic speed controllers to control the electric ducted fans and one or more microcomputers assuring (a) module flight stability by control of the electric ducted fans given the input of the inertial navigation system, (b) flight planning and (c) inter-module communication.

### BACKGROUND TO THE PRESENT INVENTION

The present invention relates to the field of electric and electric-hybrid aviation and in particular to the design of stable flying platforms and vehicles capable of VTOL (Vertical Take-Off and Landing) operation.

GB-2468787 (Geola Technologies) describes an electric VTOL aircraft comprising a plurality of electric ducted fans arranged in various orthogonal directions. The main lifting fans were conceived to have at least two different diameters. Large fans ensure a more efficient lifting force and smaller fans complement these larger fans to provide a smaller, less efficient but much more reactive thrust component. The choice of using different sized fan units obviated the need for complex vane systems as used conventionally.

The concept described in GB-2468787 (Geola Technologies) allows for the design of a highly controllable electric aircraft capable of VTOL and linear flight operations. Nevertheless, the use of smaller high exhaust-velocity fans for reactive thrust control comes at the price of reduced efficiency and an associated reduced flight autonomy.

It is desired to provide an improved VTOL aircraft.

### SUMMARY OF THE PRESENT INVENTION

According to the present invention there is provided a VTOL aircraft composed of or comprising a plurality of autonomous lifting modules wherein each autonomous lifting module is composed of a physical structure in which are mounted:

one or more electric ducted fans;

an electrical energy storage system to drive the electric ducted fans;

a charging and energy storage monitoring system to charge and monitor the electrical energy storage system;

an inertial navigation system;

electronic speed controllers to control the electric ducted fans; and

one or more microcomputers assuring (a) module flight stability by control of the electric ducted fans given the input of the inertial navigation system, (b) flight planning and (c) inter-module communication.

The present invention describes an improved configurable electric VTOL aircraft using a modular concept based on optimized counter-rotating electric ducted fans of high static thrust.

The arrangement disclosed in GB-2468787 (Geola Technologies) describes only fixed-configuration aircraft rather than configurable aircraft. Furthermore, the disclosed arrangement does not describe the use of electric ducted fans comprising twin counter-rotating low-blade-number propellers, a technology which is extremely advantageous in increasing overall efficiency. Nor, for example, does GB-2468787 (Geola Technologies) address the proper design of different thickness airfoil sections containing pluralities of electric ducted fans in terms of obtaining optimum efficiencies by the correct choice of EDF diameter.

The electric ducted fans preferably comprise counter-rotating electric ducted fans comprising two brushless motors and two counter-rotating propellers.

The VTOL aircraft preferably further comprises supplementary shape modules to provide the aircraft with a desired shape.

According to a preferred embodiment one or more of the modules have additionally one or more sets of movable vanes in order to close the upper and/or lower module surfaces in linear flight mode and to effect thrust vectoring in VTOL mode.

The VTOL aircraft preferably further comprises one or more gas turbine thrust modules and one or more fuel tank modules to provide the aircraft with additional thrust and flight autonomy.

The VTOL aircraft preferably further comprises one or more auxiliary power unit (APU) modules and one or more fuel tank modules to provide the aircraft with additional thrust and flight autonomy.

According to an embodiment one or more of the modules preferably assemble themselves, in use, in the air.

According to another aspect of the present invention there is provided a method of constructing an aircraft comprising:

combining a plurality of modules wherein each module comprises a physical structure in which are mounted: (i) one or more electric ducted fans; (ii) an electrical energy storage system to drive the electric ducted fans; (iii) a charging and energy storage monitoring system to charge and monitor the electrical energy storage system; (iv) an inertial navigation system; (v) electronic speed controllers to control the electric ducted fans; and (vi) one or more microcomputers for assuring: (a) module flight stability by control of the electric ducted fans given the input of the inertial navigation system; (b) flight planning; and (c) inter-module communication.

The present invention describes a modular system for building an electric VTOL aircraft. In general there exist several types of module. The most common type of module is the lifting module which is composed of a structure within which four or more vertically-mounted electric ducted fans, a battery system and flight control and power management electronics are mounted.

Every lifting module preferably constitutes an independent unit capable of autonomous flight.

Each lifting module is preferably capable of providing a certain additional vertical thrust, allowing it to support or carry a payload.

Lifting modules may be assembled together through a locking mechanism to provide a larger aircraft with a proportionately greater payload capacity. Modules preferably communicate with each other either through near-field communication technology, Wi-Fi or wired connections. Other types of module are also available. In particular: (a) Lateral propulsion modules comprising lateral fans for lateral propulsion; (b) Gas turbine modules comprising a conventional gas turbine for additional lateral or vertical propulsion; (c) Payload modules comprising space for carrying a payload or for carrying specialised equipment such as a crane, camera equipment, agricultural spraying equipment, tanks for such equipment and tanks required by other modules such as jet fuel (see b above and f below), modules for carrying small drones and/or other radio-command (RC) light aircraft, small multi-copters etc; (d) Passive modules comprising light but strong passive structure sections required to complete a desired aircraft shape; (e) Pilot/crew/Passenger cabin module comprising a module for a pilot and/or crew and/or passengers; (f) APU (Auxiliary Power Unit) module comprising in-flight charging capability for embarked modules from a gas-turbine/generator unit; (g) Avionics and communications master modules comprising all avionics required for a certain mission; (h) Rocket Parachute module for safe recovery of the aircraft; (i) Landing gear modules comprising different types of landing gear required for different mission profiles; (j) Airbag modules for sea or emergency landing; (k) Communication modules for control and data transfer including but not limited to radio, GSM, Wi-Fi, laser communication, satellite communication etc; (l) Remote battery charging modules such as photovoltaic, near-field, microwave or laser energy receiver modules; (m) Weaponry modules for military applications; (n) Fuel and energy reserve (batteries) modules; (o) Robotic tooling modules such as robotic arms, robotic drills, screw drivers, etc; and (p) Airship modules to support lifting heavy weights.

It will be clear to someone skilled in the art that many other types of module may also be conceived of.

Modules allow an aircraft to be configured and tailored to a given mission. In general a certain set of modules can be configured in a number of ways. For example, a drone capable of fulfilling the role of an aerial crane may be assembled from a plurality of lifting modules and a payload-crane module. To increase the lifting capacity of the crane for a given flight autonomy, it is simply a matter of adding more modules as each lifting module is capable of supporting both itself and a given payload.

The modular concept may be used in three ways. In the first way, an aircraft can be designed and manufactured with a desired customised configuration. The aircraft is not designed to be disassembled into its component modules no more than a car is designed to be disassembled into a chassis and engine. The advantage here is that a given design of aircraft may be achieved more easily using standard modules and only customised passive modules are required to complete this type of aircraft. In this option, the module concept is used as a way of manufacturing.

In the second way, the modular concept is used in a deeper fashion. Here an aircraft is designed to be repeatedly assembled and disassembled into its modules during its lifetime. This allows the aircraft to be easily transported and then assembled when needed. In addition the autonomous modules may even assemble and disassemble themselves. By using all autonomous modules, or the concept of helper modules, the aircraft can completely assemble and disassemble itself.

The third way of use is a variant of the second way of use. Here a given set of modules are designed to form two or more configurations. This is the most general form of use and allows for different aircraft to be built from the same set of modules. Typical advantages are: (i) an aircraft can be assembled in an optimum way for a given task; (ii) the ability to fulfil many tasks will require only a given set of modules rather than many aircraft; and (iii) aircraft can sub-divide in flight and fulfil different mission profiles.

The lifting modules can be designed to incorporate vanes which can both deflect air thus altering the thrust direction or close completely when transition to linear flight is required, thus reducing aerodynamic drag. In this way the surface of a wing can be designed to enclose a plurality of electric ducted fans. In linear flight the wing is closed. In VTOL flight mode, multiple vanes which define the closed wing surface rotate to reveal the electric ducted fans required for vertical thrust.

High stability flight is achieved in VTOL mode by limiting the size of the electric ducted fans, designing the brushless motors and rotors to have low mechanical inertia and by proper choice of the driving electronics. Direct control of the electrical power to the brushless motors within the electric ducted fans is then capable of allowing extremely rapid thrust control. By suitable inter-module communication this allows extremely stable flight control of the full aircraft. In addition, by the use of modules having different thrust directions, aircraft may be built with extraordinary motion freedom. For example an aircraft may be constructed that is designed to have the capability to take-off and rotate about any axis in a stable fashion.

According to another aspect of the present invention there is provided a VTOL aircraft composed of a plurality of autonomous lifting modules. Each of the autonomous lifting modules is preferably composed of a physical structure in which are mounted preferably one or more electric ducted fans, preferably an electrical energy storage system to drive the electric ducted fans and preferably a charging and energy storage monitoring system to charge and monitor the electrical energy storage system, preferably an inertial navigation system, preferably electronic speed controllers to control the electric ducted fans and preferably one or more microcomputers assuring (a) module flight stability by control of the electric ducted fans given the input of the inertial navigation system; and/or (b) flight planning; and/or (c) inter-module communication.

According to another aspect of the present invention there is provided a method of constructing an aircraft comprising combining a plurality of modules. Each said module preferably comprises a physical structure in which are mounted preferably (i) one or more electric ducted fans, preferably (ii) an electrical energy storage system to drive said electric ducted fans, preferably (iii) a charging and energy storage monitoring system to charge and monitor said electrical energy storage system, preferably (iv) an inertial navigation system, preferably (v) electronic speed controllers to control said electric ducted fans and preferably (vi) one or more microcomputers for assuring: (a) module flight stability by control of said electric ducted fans given the input of said inertial navigation system; and/or (b) flight planning; and/or (c) inter-module communication.

### BRIEF DESCRIPTION OF THE DRAWINGS

Various embodiments of the present invention will now be described, by way of example only, and with reference to the accompanying drawings in which:

FIG. 1 shows a lifting module according to a first preferred embodiment of the present invention;

FIG. 2 shows an Electric Ducted Fan comprising two counter-rotating propellers according to a preferred embodiment;

FIG. 3 shows modules assembled to form a crane according to an embodiment of the present invention;

FIG. 4 shows variants of module construction;

FIG. 5 shows three modules used to produce a wing surface according to a second preferred embodiment of the present invention; and

FIG. 6 shows a group of lifting modules supporting a passenger module.

### DETAILED DESCRIPTION OF PREFERRED EMBODIMENT

### First Preferred Embodiment

A preferred embodiment of the present invention will now be described.

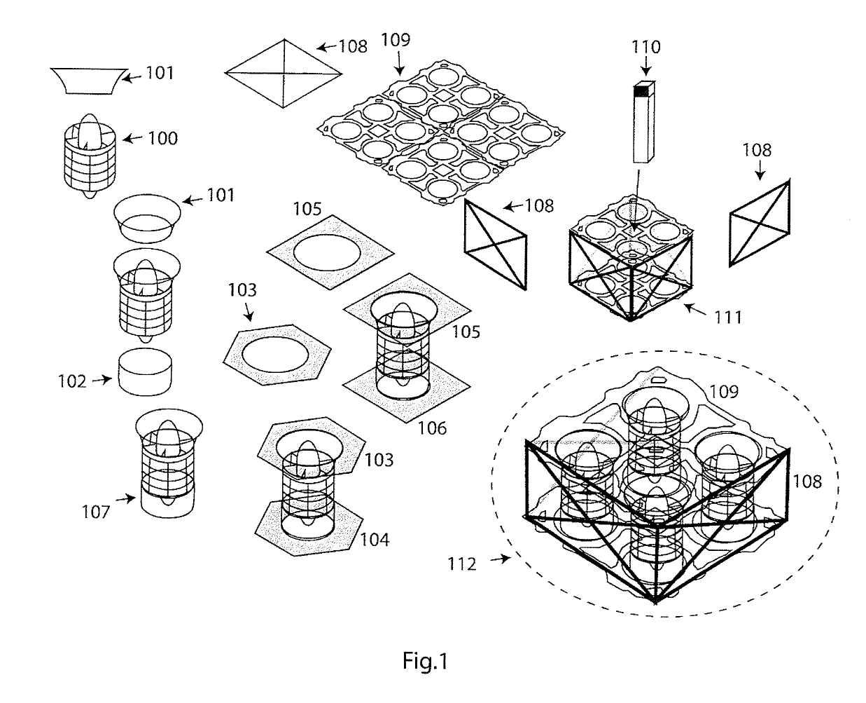

FIG. 1 shows a lifting module according to a preferred embodiment of the present invention. The preferred module is based around four electric ducted fans 100 which each preferably comprise two counter-rotating multi-bladed propellers driven by two brushless DC motors.

Inlets 101 and outlets 102,107 ensure optimal air intake and output giving an optimal thrust to electrical power ratio. Further adaptors 103,104 or 105,106 are preferably used for integrating seamlessly the electric ducted fan units into the module unit 112.

The module is preferably made from strong lightweight two-dimensional components 108,109 and preferably comprises a central heat sink block 110.

The completed module 112 preferably contains sufficient free space within the outer confining frame and outside the electric ducted fans for a lithium polymer (or other battery system and electronics to be mounted (not shown).

Generally the electronics integrated into the module preferably comprises an electric charger and battery monitoring system, electronic speed controllers for each electric ducted fan, inertial navigation system, flight-control system, module communication system and near-field communication connector. The heat sink unit 110 may also be replaced or supplemented by different utility modules (e.g. by an electric winch if one or more modules are to be used as a crane).

FIG. 1 shows a diagram of the module used in the preferred embodiment. Four electric ducted fans 100 are used in this module. Each fan, which has a central diameter of 180 mm is mated to an inlet 101 which expands the diameter of the fan to 230 mm over a longitudinal distance of 60 mm. This inlet ensures optimally smooth airflow into the electric ducted fan. Generally the inlet is made from carbon fibre and has the following shape from upstream to downstream: (i) tangent to horizontal; (ii) quarter of an ellipse; and (iii) tangent to vertical. Outlets 102 also act to optimise the exit airflow. The shape of these outlets is defined by mixing two parabolic functions.

The module structure itself is made out of the material DURAL™ which is extremely light and relatively strong. The components 108,109 of the structure are two-dimensional and hence can be produced extremely easily by, for example, laser cutting.

The structural components 108, 109 are assembled to the electric ducted fans once the fans have been joined to their in- and out-lets. The fans then act to strengthen further the structure.

Carbon-fibre adaptors 105,106 close the module. These are required for safety, aerodynamics and protection of interior components.

The total module forms a rectangular cuboid of dimensions 500 mm×500 mm×200 mm. The space interior to the external structure and exterior to the electric ducted fans allows ample space for the location of a battery system and electronics. Each module weighs 2.5 kg exclusive of batteries. The power consumption of the electric ducted fans is approximately 700 W (350W per motor and the thrust of each unit is 27N). The maximum thrust of the module is four times this or 108N. The useful vertical thrust is then 83.5N as the module must support its own weight.

6 kg of lithium polymer batteries are used in each module. The measured energy density of these cells is 473 MJ/kg giving a useful energy of just over 2.8 MJ. This gives a net maximum thrust of 2.5 kgf per module and a module flight autonomy (in VTOL mode) of just under 17 minutes.

Each module incorporates electronics for: (i) charging and monitoring the battery system; (ii) electronic speed control of the electric ducted fans; (iii) inertial navigation system including differential GPS, magnetometers and precision altimeters; (iv) flight control; and (v) inter-module communications via Wi-Fi or near-field or physical contact systems.

The electronics are mounted in the heat sink unit 110 with the exception of the battery chargers/monitors which are attached to the batteries themselves. A small fan at the top of the heat sink unit and an aluminium construction allows adequate heat removal. In addition the heat sink contributes to the structural strength of the module.

### Battery System Charging

The battery charger/monitors weigh in total 350 g. They are based on an in-house design using an LTC6802-2 chip and an MSP430. The charger/monitor system provides for the voltage monitoring of each Li-Poly cell and its charging. Charging is accomplished by 240V AC. Each module has both a 240V AC connector and a physical 240V AC connection to its neighbour meaning that all modules may be charged by simply plugging only one module into the mains. The charging system will autosense the presence of 240V AC and will commence charging when this voltage is detected. Although charging is usually done on the ground the system also allows for charging during operation and indeed flight.

### Flight Control and Systems Management

Each module contains a flight processor. This is based on an ARM Cortex-M4F microcontroller running at 168 MHz with 192 KB RAM and 1024 KB of flash. The flight processor also contains two 3DOF MEMS accelerometers packaged together with two 3DOF gyros (MPU-6050), two 3DOF HMC5883L magnetometers, two MS5611 barometric pressure sensors and a differential GPS system. The flight processor uses PID algorithms to control the electronic speed controllers and Kalman filtering technology to derive accurate and rapid (update loop time <5 ms) positional information from the MEMS accelerometers, gyros, magnetometers, barometric pressure sensors and differential GPS. This ensures stable instantaneous flight. Another Cortex-M4F processor deals with module systems data, flight planning and inter-module communications (Module System Computer).

### Electronic Speed Controllers

Eight electronic speed controllers are used in the module. These are an in-house design. These devices use serial port communication with the flight control computer and are capable of extremely quick reaction (<5 ms). This is of vital importance to module flight stability as it is essential that thrust change commands from the flight control computer be acted on with the absolute minimum delay. The heat produced by the electronic speed controllers is dissipated by the heat sink 110.

### Inter-Module Network Communication

In the preferred embodiment a physical wired Ethernet is used to connect all modules together. It will be clear to someone skilled in the art how such a wired network may be replaced by a Wireless network and indeed how different types of networks may be employed.

A copy of the flight plan and of the module configuration is generally uploaded to the aircraft prior to take-off and then automatically copied to each one of the module system computers. The module system computers then instruct their associated flight control computers to incrementally progress the flight-plan. If a module becomes inoperable, each of the other modules immediately becomes aware of this situation and can be pre-programmed to take remedial action.

Since every lifting module is autonomous and seeks to control its own flight through PID iteration, when several modules are connected together, inter-module communication acts to equalise as much as possible the power consumption of each module. In principle, if such a scheme were not applied one or another module could essentially end up “taking most of the weight” and as a result these modules would have a drastically reduced flight autonomy. Hence each module is programmed to compare its load with all other modules and a weighting algorithm then reduces the thrust of those modules with high power load and increases the thrust of those modules with lower power load. This iteration happens on a timescale rather slower than the individual PID module flight stability loop and is generally defined as a multiple (usually >>10) of the basic flight stability heartbeat of <5 ms. In order to prevent possible aliasing preferably the individual flight stability heartbeat clocks are synchronised. Less preferably they are systematically de-phased in an ordered manor.

### Counter-Rotating Electric Ducted Fan

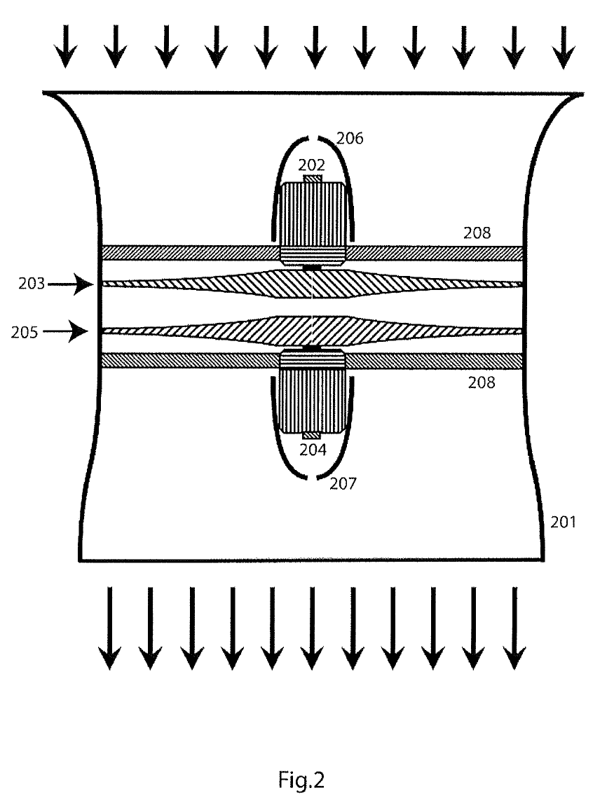

FIG. 2 shows an Electric Ducted Fan comprising two counter-rotating propellers 203, 205. A light-weight but strong carbon fibre shell 201 forms the duct. Two brushless DC motors 202, 204 are mounted on aluminium rod support structures 208 which also serve to transport the electrical power wires. This structure is chosen to present the minimum surface area to the incoming air and is composed of a central aluminium cylinder supported by two orthogonal thin rods. Shrouds 206, 207 are attached to the central cylinder optimising airflow whilst also allowing cooling of the motors.

FIG. 2 shows a diagram of the electric ducted fan employed in the preferred embodiment. This fan comprises two counter-rotating multi-bladed propellers. The main (cylindrical) body of the unit has a diameter of 180 mm and a length of 60 mm. An inlet increases the diameter to 230 mm in 60 mm longitudinal distance and an outlet increases the diameter to 196 mm in 80 mm. Each brushless DC motor consumes 350 W and weighs 55 g. Propellers and case are made from carbon fibre. When comparing the efficiency in terms of thrust per unit electrical power consumed, using a counter-rotating scheme one gains about 5-15%. In addition, using a ducted fan rather than an un-ducted fan, one sees an improvement of around 80%. Overall then using a ducted counter-rotating scheme one can expect an approximate doubling of efficiency.

Counter-rotating propellers also solve the problem of induced angular momentum and the onset of induced and unwanted yaw. By adjusting the relative power between the two rotation directions, angular momentum may be controlled very accurately whilst keeping the thrust constant. As such the yaw of a module or of a set of modules may be suitably controlled without additional lateral fans.

It is also possible to add a stator row in order to further optimise relative power sharing between the two motors at zero angular momentum.

From Froude or actuator theory it is clear that the efficiency of an electric ducted fan depends critically on the exhaust air velocity. In fact thrust per unit power varies as 1/v where v is the exhaust air velocity. Accordingly, the fan unit used in the preferred embodiment has been designed to have relatively small motors driving relatively large propellers. The motors have been chosen for their low inertia as it is vital that thrust commands be translated into physical thrust change in the smallest period of time possible. If motor inertia is too high, this will cause a delay which will degrade flight stability. The propellers must also be designed properly and here again low inertia is a prime consideration. In practice twin-bladed propellers have been found to produce the best efficiency in terms of thrust per unit electrical power consumed. Using computational fluid dynamics simulations further efficiency gains are possible.

According to the preferred embodiment thrust to power values of around 4 kgf/kW have been achieved for the small turbine described. However, with further optimisation using CFD this should be able to be increased to between 7 kgf/kW and 8 kgf/kW. These values represent a large gain when compared to the case of unducted rotors.

Multi-Module Crane

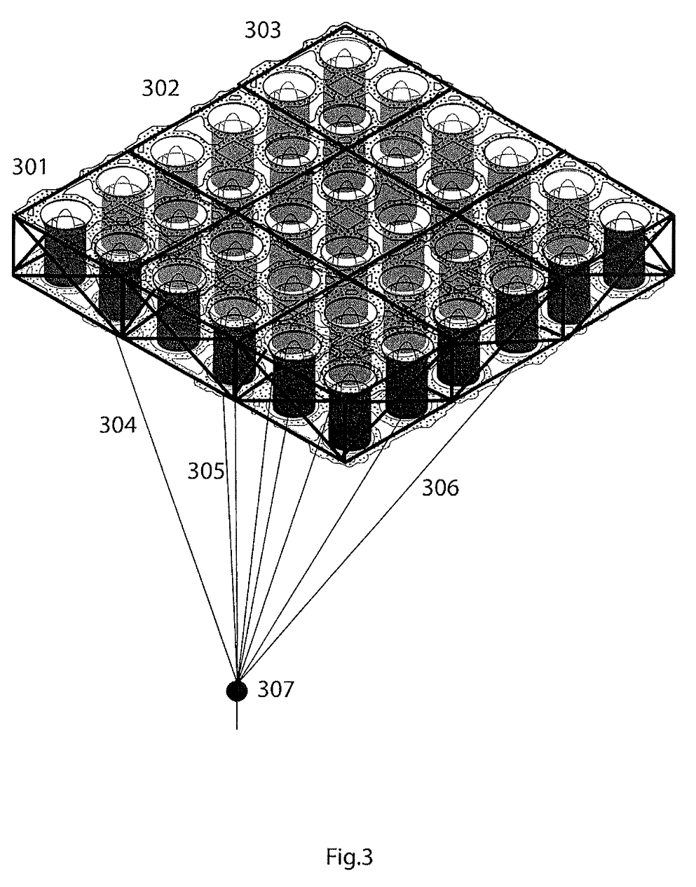

FIG. 3 shows modules assembled to form a crane according to an embodiment of the present invention.

The crane is preferably composed of nine modules 301,302,303 . . . connected together in the form of a square array. Each module 301,302,303, . . . has a centrally mounted electric winch connected to a wire 304,305,306, . . . . The wires are joined at a hook which lifts an object 307. The modules are drawn schematically only.

The nine modules (e.g. 301, 302, 303 . . . ) are connected together in order to form a small aerial crane. A small electric winch, capable of lifting a maximum of 15 kg, is mounted on each of the modules underneath the heat sink 110 and is connected to wires 304, 305, 306 etc. The winch is electrically connected to the module system computer and controlled either by an uploaded program or by a human operator in the case that crane is operated under manual control. Each module is capable of lifting 10 kg (limitation of vertical thrust) and hence the crane is capable of lifting a maximum load of 90 kg over a period of around 17 minutes. The system is programmed to apportion equally the load force between all modules.

In the preferred embodiment the aerial crane moves laterally by rolling or pitching. Yaw is controlled by adjustment of the relative power fed to the rotating and counter-rotating propellers.

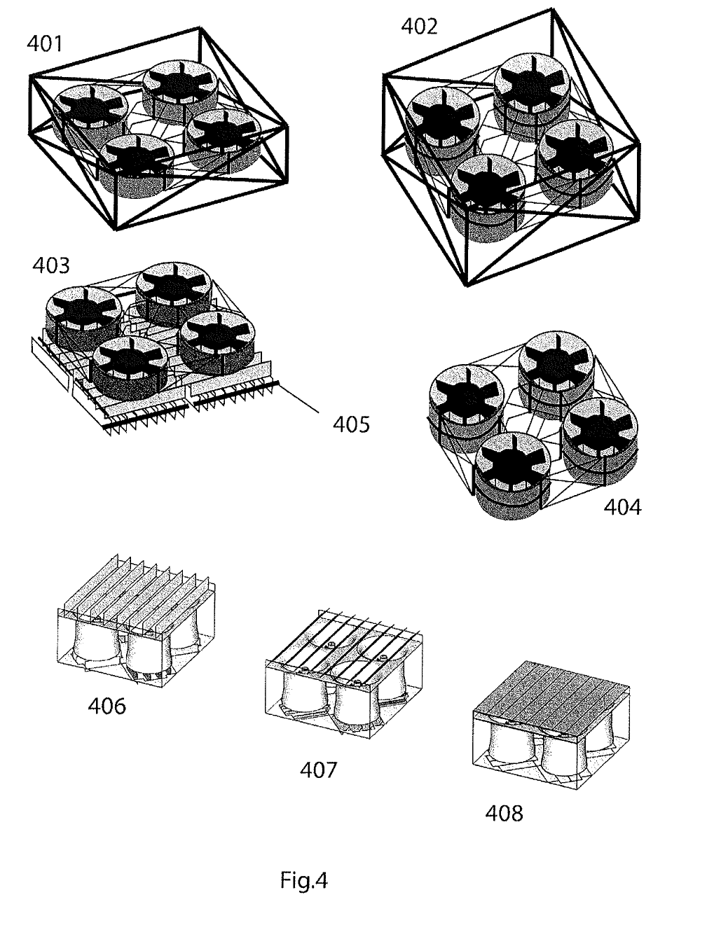

In another embodiment however vane systems 405 are added beneath the modules as shown in FIG. 4.

FIG. 4 shows variants of module construction. 401 shows a module structure with enlarged central bay and only the central portion of each electric ducted fan. 402 and 404 show the same module structure but now with the central portion of the electric ducted fans and outlet adaptors. 403 shows how a module may be designed incorporating a controllable vane system 405 beneath each electric ducted fan for thrust vectoring.

Here the exhaust air is deflected in one of four directions thus inducing a lateral thrust component. In general there are many ways to design such vane systems as someone skilled in the art will realise. For instance here we have shown for simplicity an arrangement where two orthogonal vane systems are stacked one on top of the other. However we could have shown a single set of vanes for each fan in the module, where the direction of the vanes changed from module to module.

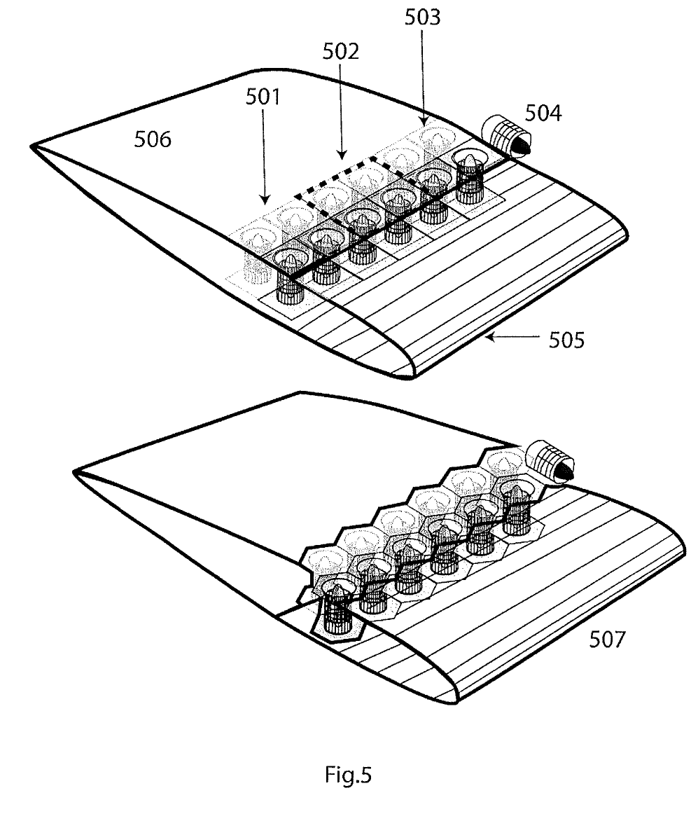

Variants 406,407,408 show a module arrangement where vanes are used both at inlet (top) and outlet (bottom). In this configuration the vanes may, in addition to providing vectored thrust, be used to close (see 408) the module forming a flat skin on both the top and bottom surfaces. This is useful when modules are to be incorporated into lifting surfaces which must function efficiently (both in terms of sufficiently low drag and sufficiently high lift) over a range of linear velocities (see, for example, FIG. 5).

In addition lateral motion may be controlled in a further embodiment by the use of separate lateral fans.

### Generalisation, Extension and Advantages

The concept of the modular aerial crane may of course be generalised in many ways. Most simplistically the modules may be scaled up or more of the same modules used. For example 25 modules may be used to lift 250 kg. Or 100 modules may be used to lift 1 tonne. If too many modules are connected, it may happen that the lateral forces become too great when lifting heavy loads and in this case extra structural support may be necessary. This may be effected in many ways by, for example, simply increasing the module strength or in another embodiment by attaching a light-weight structural exoskeleton to module combinations.

Different geometries may also be built up by module groups. The crane does not have to consist of a square structure. The advantage of the module concept is that specific geometries may be configured for a given application. For example a long thin crane may be required when space is not available for a square crane. In addition other modules may be included into the crane module. These may be, for example, visual recognition modules which can allow the crane to operate using an automatic program and to perform automated tasks.

One of the advantages of the modular aerial crane is that it may be stored very compactly. For example each module in the preferred embodiment measures 500 mm×500 mm×200 mm and weighs 16 kg with batteries. Nine modules can therefore be stacked into a space of 1.5 m×0.5 m ×0.6 m. This allows such an aerial crane to be carried in a standard SUV. Such aerial cranes may have many uses including, for example, the rescue of stranded humans in inaccessible locations.

Another advantage of the modular aerial crane is that in a further embodiment it can assemble itself in mid-air. Each module is autonomous and can potentially communicate at a distance with every other module by RF communication. This allows modules to fly through small entrance holes to an interior space and then to assemble into a large crane within such interior space. If the entrance holes to the interior space are bigger than the module size but smaller than the assembled crane size this would not have been possible had the crane not been composed of modules. Such possibilities are likely to be useful in rescue operations where rapid deployment is required in difficult and hazardous environments.

In-air self-assembly requires modules to be fitted with specialised systems which are capable of locking and unlocking on near-contact. In general extremely high precision positioning is required for this operation. Preferably such modules are fitted with mechanical, electromagnetic or pneumatic systems which are capable of locking when two modules are at a distance of several centimetres from each other. In addition, preferably each module contains a micro-camera or other similar device for locating its partner when in near-contact. This is because the differential GPS systems in each module may not always have the precision required for docking and so a higher accuracy proximity sensing system may be required. Two modules approaching one another in flight, with the intention of docking, will in general execute a calculated flight plan which both modules update continuously. Preferably such flight plan will instigate a controlled low-velocity collision of the modules which causes locking.

In-air self-assembly of the aerial cranes also requires coordination of the individual winches. In manual assembly the wire from each winch is joined to a central hook. However when the crane is designed to self-assemble, a system for joining each winch wire to the central hook is required. Preferably this requirement is obviated by using a single winch module instead of multiply connected winch modules. Less preferably an additional special autonomous module may be used in order to take each of the winch wires and to join them to the crane hook, one by one. This module may form part of the crane or may constitute a constructor module used only for in-air construction. It may also constitute a hook module.

A further advantage of the preferred embodiment is its ability to operate in ATEX environments. Owing to the use of brushless DC motors and the absence of hot components, sparks and combustion, the modular aerial crane of the preferred embodiment is able to operate in environments containing explosive gases. So too such a modular crane may be taken to the edge of an ATEX site for example by helicopter and the modules then launched automatically from the helicopter.

A yet further advantage of the modular aerial crane of the preferred embodiment is its redundancy. In the case that one module malfunctions it can be shut down and the remaining modules will be able to continue operating, albeit with slightly reduced lifting capability. In a military arena, modules may be destroyed through enemy fire and can then be ejected from the crane by mutual decision of the remaining modules (note again that special attention must be paid to winch wires and in this case an intelligent hook module is preferred which is capable of releasing the relevant hook winch wire). The crane may continue to function with many modules destroyed. Further modules can then be called for to replace the destroyed modules.

In order to improve the flight autonomy of the modular aerial crane, an auxiliary power unit (“APU”) may be added. These devices, which were developed for commercial aircraft, consist of gas turbines connected to a generator for the creation of electrical power. Such APUs are now becoming more and more efficient and lighter and lighter. It is therefore possible in a further embodiment to add to the modular aerial crane a special APU module in order to recharge on-board the battery systems.

An alternative embodiment is to use one or more small gas turbines in a module in order to provide additional thrust. For example the Nike turbine from AMT produces around 800 N of thrust for a weight of roughly 10 kg. Further fuel reservoir modules would then be required. Using either an APU module or an assisted thrust gas turbine module, it is possible to double the present flight autonomy of 17 minutes.

An alternative strategy to increasing flight autonomy is to increase the size of the module and electric ducted fans proportionately whilst keeping the electrical power constant. This produces a lower air exhaust velocity and so a greater efficiency in terms of thrust produced per unit of electric power consumed. However the challenge here is then to keep the structural weight down for the larger module size whilst not compromising the module strength. Practically materials technology limits this strategy.

Ultimately the flight autonomy of the modular aerial crane can best be increased by increasing the energy density in the battery system. Lithium Air technology potentially promises to yield flight autonomies of around 20 times that of Lithium polymer-converting the flight autonomy of the preferred embodiment from 17 minutes to nearly 6 hours.

### Second Preferred Embodiment

FIG. 5 shows three modules 501,502,503 used to produce a wing surface using front (505) and rear (506) profile modules. One or more electric ducted fans 504 can be used to produce lateral thrust. The variant 507 shows a wing composed of modules having a different geometric form.

FIG. 5 shows a second embodiment of the invention. Three modules are stacked together 501, 502, 503 and combined with shape modules 505,506 to produce a wing shape. 507 shows a variant where differently shaped modules are employed. The concept is designed to be integrated with the preferred embodiment. By including two such wing modules on either side of the aerial crane, and by using lateral fans 504 for lateral propulsion the aerial crane may be made to travel at up to 70 km/hr in a lateral direction. At these speeds the aerodynamic lifting force from the wing is considerable and hence the range of the aerial crane and its flight autonomy are greatly extended. Vanes may also be used to close the top and bottom of the modules in the wing section so that, at speed, these modules are shut down and the wing becomes a normal wing with greater lift and less drag (FIG. 4). Exactly the same vanes used to shut the bottom side of the wing may used in VTOL mode for thrust vectoring as in FIG. 4.

More general combinations of lifting modules and shape modules may be used to construct many types of aircraft. In general each lifting module is autonomous but other modules such as shape modules, payload modules, fuel modules etc will not be autonomous. Where a module is not autonomous and where in-flight assembly is required, in general this must be the responsibility of adjacent modules. In some cases this will be a single module and in some cases this will be multiple modules. In cases where there are not enough adjacent modules to support a given passive module, a helper module may be allocated. Such helper modules may form part of the aircraft (but not in the immediate vicinity of the passive module in question) or they may constitute new modules which are required only for in-air assembly of the aircraft. In general the assembly plan of the required aircraft shape is stored in each of the module system computers.

In general a wing section must have a certain maximum thickness in order to operate efficiently. This means that for a given wing design, modules must have a certain height if they are to be placed within the wing at a given position. The counter-rotating ducted turbine possesses an essentially optimal efficiency at which the width of the turbine is a constant factor times its height. As such, the diameter of turbines used in a wing section may be chosen to match the height requirement of the module such that turbines can be inserted into the wing section properly. Since the power of BLDC motors scales approximately linearly with their weight, the overall efficiency of a module is rather insensitive to the individual turbine size used. Hence large thick wings will generally use larger diameter turbines in the inserted modules whereas smaller or thinner wings will generally use a greater number of smaller turbines. In addition, a wing section tapers towards the rear and so several rows of modules, having different thicknesses, may be used to “fill” the wing better. Thin modules (used towards the rear) will generally use a higher number of smaller turbines whereas thicker modules will use a lower number of larger diameter turbines.

There are of course limits to the process of using many small turbines in a given module size in order to reduce the modules thickness. If too many turbines are used structural weight and module rigidity can become issues. Nevertheless, a module of a given cross sectional area can be created using a significantly different number of turbines for a roughly equal thrust and power consumption but differing thickness.

### Different Module Sizes and EDF Configurations

The module described in the preferred embodiment constitutes a particular choice. In general three electric ducted fans are the minimum number of fans required for adequate autonomous flight stability of a single module. However a module of 0.5 m×0.5 m could be designed with a single large fan. Such a module would not be autonomous but could be effectively autonomous in conjunction with 2 or more adjacent modules. In general the optimal thickness of an electric ducted fan including inlet and outlet scales with diameter. So large fans naturally lead to thicker modules. Certainly there may be occasions where thicker modules are required and here it may be advantageous to use larger diameter electric ducted fans. However this can come at a price as generally the larger the diameter of the fan, the slower is the response time of the fan. Where the fan is used for its simple static lift this is not a problem but if it is to contribute to the active flight stability of the entire aircraft then it must have fast reactivity. For this reason it is preferred that the electric ducted fans of the invention be relatively small. Further preferably the diameter of the fans should be in the range: (i) 100 mm-200 mm; (ii) 200 mm-300 mm; (iii) 300 mm-400 mm; (iv) 400 mm-500 mm; (v) 500 mm-600 mm; (vi) 600 mm-700 mm; and (vii) 700 mm-800 mm.

More electric ducted fans may be installed into a single module. In fact, since the scaling of motor power to motor weight for BLDC motors is roughly linear, it is possible to choose to have rather larger numbers of fans provided that the efflux air velocity remains the same as in the original module definition. This leads to thinner modules but with otherwise very similar characteristics to those of the modules described in the preferred embodiment.

It is also possible to increase the power of the electric ducted fans so that a module of 0.5 m×0.5 m is capable of lifting a much larger weight. However this comes at the price of flight autonomy.

Modules may also be constructed to be larger.

Modules may also be constructed in be smaller. For example the module of the preferred embodiment may be scaled down by a linear factor of 5. This could be the basis for a much smaller scale series of aerial robotic machines. Such applications could for example involve factory, office, military or domestic use. A further example includes a flying toy composed of modules. Such modules may be programmed to self-assemble in the air and/or to form different configurations such as flying cranes, gunships, aircraft etc.

### Generalisation of the Lifting Module

Several different types of module have been discussed above. The main module preferably comprises an autonomous lifting module. This module may be modified with servo-controlled vanes to form part of a wing or body surface. In general this type of modified module can be made up from distinct layers. The central layer contains the electric ducted fan central cylinders including motors and propellers. A layer on top of this includes the inlets and a layer on the bottom, the outlets. Then two further layers, one on the top and one on the bottom, contain series of vanes which have two functions. The first is to close the module top and bottom surfaces (forming a smooth outer surface). The second is for vector thrust control. All five layers may be assembled together simply. Someone skilled in the art will however realise that there are many ways to build such modules. Less preferably one or more of the vane systems may act only to open and close the structure. Further less preferably different solutions such as irises or sliding panels rather than rotating vanes may be used to open and close the structure.

Modules may also be built with slanted or profiled surfaces. For example, it may be required to incorporate several rows of lifting modules into wing structures. Aft-mounted modules will require a profiled top and bottom section as not only does the wing taper here but it is also curved.

### Hybrid Modules

Hybrid modules may be of the APU or assisted thrust variety. These have been described above. They are also associated with fuel reservoir modules.

### Lateral Thrust Modules

Lateral thrust may be derived from roll and pitch control of the main lifting modules or vanes systems/vector thrust control. Alternatively separate lateral thrust modules may be used. These modules will in general not be autonomous modules and will consist of one or more electric ducted fans for horizontal propulsion. Usually higher efflux air velocity is required as one needs a higher dynamic thrust for high-speed forward propulsion.

Alternatively conventional gas-turbine propulsion units can be used.

### Payload Modules

Payload modules may be used to carry any type of payload. For example an aircraft may be built from modules to do crop spraying. Here one or more payload modules would contain the chemical spraying equipment and the chemical itself.

### Pilot and Passenger Modules

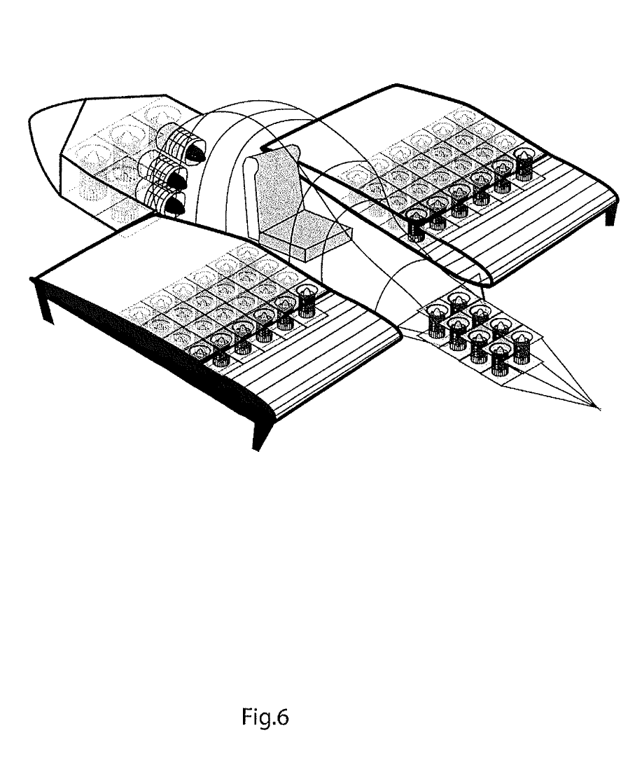

FIG. 6 shows a simplistic passenger module attached to a plurality of lifting modules. In general an aircraft may be assembled from modules and configured to carry one or more pilot or passenger modules.

### Structural and Shape Modules

These are passive modules which provide additional strength to a given multi-module configuration or provide required aerodynamic shape.

### Other Modules

Many other types of modules may be envisioned: For example parachute modules permitting safe recovery in the case of an accident, camera equipment modules for surveillance, robotic manipulation modules perhaps permitting a craft to weld high altitude components, different forms of landing or grappling modules, permitting a craft to attach itself to various structures perhaps for rescue operations, laser equipment modules for atmospheric analysis, spraying equipment modules for agriculture, hedge cutting modules for parks maintenance, loudspeaker modules for crowd control etc.

### Redundancy and Safety

One of the major advantages of the present invention over the prior-art is redundancy. A given multi-module configuration is inherently redundant. This means that if a module fails the aircraft can continue to fly. In fact, the aircraft has several options. The first is just to continue to fly. The second is to eject the faulty module. The third is to use one or more adjacent modules to fly the faulty module to a safe location and then to regroup with the main aircraft. Finally in the second and third options a further sub-option is to call to base for a module replacement in flight. Such redundancy confers great safety as aircraft may be designed where failure of even multiple modules is of little consequence. Intelligence (i.e. as in reference to flight control) in a given aircraft is effectively distributed over the entire multi-module network and so is not located in a single physical location as in conventional aircraft.

### Flexibility

The module concept is incredibly flexible. It allows an aircraft to be designed from a group of modules. These modules may then be transported easily and assembled on site easily. One can also design aircraft to self-assemble in flight. A given set of modules may be used to create several different configurations of aircraft, each optimised for a different mission.

### Greater Flight Stability

Flight stability of a module or combination of modules can be increased by the use of peripheral precision high-reactivity pressure sensors. In the case of a single module multiple pressure sensors are installed around the module and a microcomputer is used to build up a 3D representation of the instantaneous pressure field surrounding the module. The forces and torques acting on the module are then calculated and used within the flight control algorithm to help counter the effects of wind gusts. Generally the pressure information is felt slightly before any inertial information and can therefore be highly useful in assuring flight stability.

### Potential Applications

Modular electric aircraft and drones are likely to have diverse applications. Examples include agricultural uses such as automatic crop spraying, ATEX work in the oil and gas industry—e.g. atmospheric analysis, rescue operations for example in tall building fires and rescue work in remote or mountainous locations, surveillance and maintenance in disaster or danger areas, military applications, commercial light aviation applications such as electric VTOL passenger aircraft and point to point air-taxis, rescue vehicle drones configured to aid or evacuate conventional aircraft in trouble, aerial package delivery, construction industry uses such as aerial cranes in situations where normal cranes are impractical (e.g. in deep water/on boats etc) and building assembly, the remote assembly of flying vehicles for the exploration of other planets with normal or high pressure atmospheres, and toys.

### Energy Storage Systems

The preferred embodiment of this invention uses Li-Poly batteries as the energy storage medium. However many other forms of electrical energy storage are available or will shortly be available. These may be used instead of such Li-Poly batteries in any module. For example flywheel energy storage is presently capable of attaining 500 kJ/kg and has the advantage of great reliability and long lifetime. Super capacitors are also promising greater energy densities as are Fuel cells. Finally many different battery systems are available.

### Module Swarms

The autonomous module concept allows the concept of module swarms in various applications. For example construction work could be performed by a swarm of different modules. In this embodiment all the modules would be controlled from a central computer.

The task for building a bridge of a certain design in a certain location for example could be specified in this computer. Individual tasks could be allocated to various modules and groups of modules. For example many small aerial cranes could be responsible for taking sub-components from a stock to their assembly positions. From time to time larger components would be needed to be transported and here smaller cranes would regroup to form a larger crane. In general the activities and groupings of modules would change in an optimal fashion over time to accomplish the required construction project.

Although the present invention has been described with reference to preferred embodiments, it will be understood by those skilled in the art that various changes in form and detail may be made without departing from the scope of the invention as set forth in the accompanying claims.

1. A VTOL aircraft composed of or comprising a plurality of autonomous lifting modules wherein each said autonomous lifting module is composed of a physical structure in which are mounted:
one or more electric ducted fans;
an electrical energy storage system to drive said electric ducted fans;
a charging and energy storage monitoring system to charge and monitor said electrical energy storage system;
an inertial navigation system;
electronic speed controllers to control said electric ducted fans; and
one or more microcomputers assuring (a) module flight stability by control of said electric ducted fans given the input of said inertial navigation system, (b) flight planning and (c) inter-module communication.

2. A VTOL aircraft as claimed in claim 1, wherein said electric ducted fans comprise counter-rotating electric ducted fans comprising two brushless motors and two counter-rotating propellers.

3. A VTOL aircraft as claimed in claim 1, further comprising supplementary shape modules to provide the aircraft with a desired shape.

4. A VTOL aircraft as claimed in claim 1, wherein one or more of said modules have additionally one or more sets of movable vanes in order to close the upper and/or lower module surfaces in linear flight mode and to effect thrust vectoring in VTOL mode.

5. A VTOL aircraft as claimed in claim 1, further comprising one or more gas turbine thrust modules and one or more fuel tank modules to provide the aircraft with additional thrust and flight autonomy.

6. A VTOL aircraft as claimed in claim 1, further comprising one or more auxiliary power unit (“APU”) modules and one or more fuel tank modules to provide the aircraft with additional thrust and flight autonomy.

7. A VTOL aircraft as claimed in claim 1, wherein one or more of said modules assemble themselves, in use, in the air.

8. A method of constructing an aircraft comprising:
combining a plurality of modules wherein each said module comprises a physical structure in which are mounted: (i) one or more electric ducted fans; (ii) an electrical energy storage system to drive said electric ducted fans; (iii) a charging and energy storage monitoring system to charge and monitor said electrical energy storage system; (iv) an inertial navigation system; (v) electronic speed controllers to control said electric ducted fans; and (vi) one or more microcomputers for assuring: (a) module flight stability by control of said electric ducted fans given the input of said inertial navigation system; (b) flight planning; and (c) inter-module communication.
